(19) United States
(12) Patent Application Publication
(10) Pub. No.: US 2026/0277382 A1
(43) Pub. Date: Sep. 17, 2026

(54) INFORMATION INTERACTION METHOD AND APPARATUS, ELECTRONIC DEVICE, STORAGE MEDIUM, AND PROGRAM PRODUCT

(71) Applicant: Bytedance Technology Ltd., Grand Cayman (KY)

(72) Inventors: Zhifei CAI, Beijing (CN); Runzhi XIE, Beijing (CN); Guan-Bai CHEN, Culver City, CA (US)

(21) Appl. No.: 19/537,130

(22) Filed: Feb. 11, 2026

(30) Foreign Application Priority Data
Mar. 12, 2025 (CN) 202510298010.6

(51) Int. Cl. G06F 3/04815; G06F 3/04845

(52) U.S. Cl. CPC G06F 3/04815; G06F 3/04845

(57) ABSTRACT

Embodiments of the present disclosure provide an information interaction method and apparatus, an electronic device, a storage medium, and a program product. The method includes: receiving an addition operation for a two-dimensional object through an interaction device, determining first display information of the two-dimensional object in a local space, and rendering the two-dimensional object into a three-dimensional space according to the first display information; and determining an operation element corresponding to the two-dimensional object, determining rendering configuration information of the operation element, and rendering the operation element into the three-dimensional space according to the first display information and the rendering configuration information to display the operation element on the interaction device; where the operation element is configured to control the two-dimensional object to perform a preset operation.

### CROSS-REFERENCE TO RELATED APPLICATIONS

This application claims priority to Chinese Application No. 202510298010.6 filed on Mar. 12, 2025, the disclosure of which is incorporated herein by reference in its entirety.

### FIELD

Embodiments of the present disclosure relate to the field of computer processing technologies and, in particular, to an information interaction method and apparatus, an electronic device, a storage medium, and a program product.

### BACKGROUND

In information interaction scenarios, a flat image generally supports interaction operations such as moving, rotating, or scaling. In the related art, the interaction operations with the flat image generally depend on operation controls deeply bound to a two-dimensional object. These controls usually implement an editing function through two-dimensional interaction data.

### SUMMARY

Embodiments of the present disclosure provide an information interaction method and apparatus, an electronic device, a storage medium, and a program product to achieve an effect of displaying a two-dimensional object and an operation element thereof in a three-dimensional space in a simple and convenient manner.

In a first aspect, an embodiment of the present disclosure provides an information interaction method, and the method includes:

an addition operation for a two-dimensional object is received through an interaction device, first display information of the two-dimensional object in a local space is determined, and the two-dimensional object is rendered into a three-dimensional space according to the first display information; where the first display information includes at least display size data; and

an operation element corresponding to the two-dimensional object is determined, rendering configuration information of the operation element is determined, and the operation element is rendered into the three-dimensional space according to the first display information and the rendering configuration information to display the operation element on the interaction device; where the operation element is used to control the two-dimensional object to perform a preset operation.

In a second aspect, an embodiment of the present disclosure further provides an information interaction apparatus, and the apparatus includes:

a two-dimensional object addition module, configured to receive an addition operation for a two-dimensional object through an interaction device, determine first display information of the two-dimensional object in a local space, and render the two-dimensional object into a three-dimensional space according to the first display information; where the first display information includes at least display size data; and

an operation element rendering module, configured to determine an operation element corresponding to the two-dimensional object, determine rendering configuration information of the operation element, and render the operation element into the three-dimensional space according to the first display information and the rendering configuration information to display the operation element on the interaction device; where the operation element is used to control the two-dimensional object to perform a preset operation.

In a third aspect, an embodiment of the present disclosure further provides an electronic device, and the electronic device includes:

one or more processors; and

a storage, configured to store one or more programs,

where the one or more programs, when executed by the one or more processors, cause the one or more processors to implement the information interaction method according to any one of the embodiments of the present disclosure.

In a fourth aspect, an embodiment of the present disclosure provides a storage medium including computer-executable instructions, and the computer-executable instructions, when executed by a computer processor, are configured to perform the information interaction method according to any one of the embodiments of the present disclosure.

In a fifth aspect, an embodiment of the present disclosure further provides a computer program product, including a computer program, where the information interaction method according to any one of the embodiments of the present disclosure is implemented when the computer program is executed by a processor.

In the technical solution of the embodiment of the present disclosure, the addition operation for the two-dimensional object is received through the interaction device, the first display information of the two-dimensional object in the local space is determined, and the two-dimensional object is rendered into the three-dimensional space according to the first display information. Then, by determining the operation element corresponding to the two-dimensional object, determining the rendering configuration information of the operation element, and rendering the operation element into the three-dimensional space according to the first display information and the rendering configuration information to display the operation element on the interaction device, the two-dimensional object and the operation element may be mapped to the three-dimensional space conveniently, quickly, and accurately.

### BRIEF DESCRIPTION OF THE DRAWINGS

The above and other features, advantages, and aspects of the embodiments of the present disclosure will become more apparent in combination with the accompanying drawings and with reference to the following detailed description of embodiments. Throughout the drawings, the same or similar reference numerals represent the same or similar elements. It should be understood that the drawings are schematic and that the original components and elements are not necessarily drawn to scale.

FIG. 1 is a schematic flowchart of an information interaction method provided in an embodiment of the present disclosure;

FIG. 2 is a schematic flowchart of another information interaction method provided in an embodiment of the present disclosure;

FIG. 3 is a schematic flowchart of yet another information interaction method provided in an embodiment of the present disclosure;

FIG. 4 is a schematic flowchart of an optional example of an information interaction method provided in an embodiment of the present disclosure;

FIG. 5 is a schematic structural diagram of an information interaction apparatus provided in an embodiment of the present disclosure; and

FIG. 6 is a schematic structural diagram of an electronic device for implementing an embodiment of the present disclosure provided in an embodiment of the present disclosure.

### DETAILED DESCRIPTION OF EMBODIMENTS

The embodiments of the present disclosure will be described in more detail below with reference to the accompany drawings. Although certain embodiments of the present disclosure are shown in the accompany drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only for illustrative purposes and are not intended to limit the protection scope of the present disclosure.

It should be understood that steps described in method implementations of the present disclosure may be performed in different orders and/or in parallel. Furthermore, the method implementations may include additional steps and/or omit the execution of the steps shown. The scope of the present disclosure is not limited in this regard.

The term "include/comprise" and the variations thereof used herein are open-ended inclusions, that is, "include/comprise but not limited to". The term "based on" is "at least partially based on". The term "an embodiment" means "at least one embodiment". The term "another embodiment" means "at least one other embodiment". The term "some embodiments" means "at least some embodiments". Related definitions of other terms will be given in the following description.

It should be noted that concepts such as "first" and "second" mentioned in the present disclosure are only used to distinguish different apparatuses, modules, or units and are not used to limit the order of functions performed by these apparatuses, modules, or units or interdependence therebetween.

It should be noted that the modifications of "one" and "a plurality of" mentioned in the present disclosure are exemplary rather than restrictive, and those skilled in the art should understand that unless clearly indicated in the context, they should be understood as "one or more".

The names of messages or information exchanged between a plurality of apparatuses in the implementations of the present disclosure are only used for illustrative purposes and are not used to limit the scope of these messages or information.

It may be understood that before using the technical solutions disclosed in the embodiments of the present disclosure, the user should be informed of the type, use scope, use scenarios, etc., of personal information involved in the present disclosure and the authorization of the user should be obtained in an appropriate manner in accordance with relevant laws and regulations.

For example, in response to receiving an active request from a user, prompt information is sent to the user to clearly prompt the user that the requested operation will require access to and use of the user's personal information. Thus, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to "agree" or "disagree" to provide the personal information to the electronic device.

It may be understood that the above process of notifying and obtaining user authorization is only exemplary and does not constitute a limitation on the implementations of the present disclosure, and other manners that satisfy the relevant laws and regulations may also be applied to the implementations of the present disclosure.

It may be understood that the data involved in the technical solution (including but not limited to the data itself, acquisition or use of the data) should comply with the requirements of corresponding laws, regulations, and related provisions.

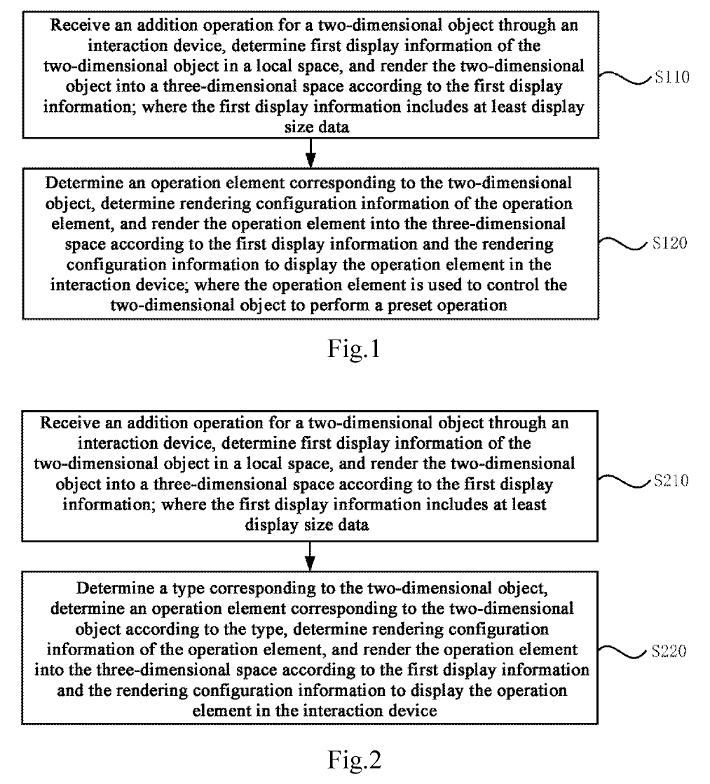

As stated above, since the operation controls are highly coupled with the two-dimensional object, the expandability is poor, and modifying the control logic easily leads to system stability problems. In practical applications, it is often difficult to migrate the interaction operations on the flat picture to three-dimensional space or other components, which greatly limits the cross-scene reuse capability. FIG. 1 is a schematic flowchart of an information interaction method provided in an embodiment of the present disclosure. The embodiment of the present disclosure is applicable to a scenario of reusing an operation element suitable for a two-dimensional space into a three-dimensional space. The method may be performed by an information interaction apparatus, which may be implemented in the form of software and/or hardware. Optionally, the method is implemented by an electronic device, which may be a mobile terminal, a PC, a server, or the like. As shown in FIG. 1, the method of this embodiment may specifically include:

S110: an addition operation for a two-dimensional object through an interaction device is received, first display information of the two-dimensional object in a local space is determined, and the two-dimensional object is rendered into the three-dimensional space according to the first display information; where the first display information includes at least display size data.

In the embodiment of the present disclosure, the interaction device may be understood as a hardware or software tool used for information exchange and control between a user and a computer, a machine, or other systems. These devices achieve interaction by receiving input from the user, converting it into instructions understandable by the system while feeding back the output of the system to the user. The interaction devices may include one or more devices that may interact with the user, such as a personal computer, a virtual reality device, a projection device, and a scanning device.

The two-dimensional object may be understood as a geometric shape or figure defined in a two-dimensional plane, which typically has a length and a width but no depth. Exemplarily, the two-dimensional object may include one or more of the following objects: a point, a line, a rectangle, a circle, and a polygon. In practical applications, the two-dimensional object may include one or more of the following objects: an image, a text box, and a collision box.

The addition operation for the two-dimensional object may be understood as a trigger operation used to add the two-dimensional object to the three-dimensional space. Exemplarily, the addition operation for the two-dimensional object may include: an operation of dragging the two-dimensional object or an object identification of the two-dimensional object into the three-dimensional space; and/or displaying object identifications of at least one two-dimensional object, receiving an identification trigger operation for the at least one object identification, and determining a two-dimensional object added to the three-dimensional space according to the identification trigger operation; and the like. Further, displaying the object identifications of at least one two-dimensional object may specifically include: displaying an object addition control, receiving a control trigger operation for the object addition control, and displaying the object identifications of at least one two-dimensional object.

In the process of rendering the two-dimensional object into the three-dimensional space, the local space (Local Space) is a key concept that describes a position, a size, and a base point of the object in its own coordinate system, regardless of its position in the world. By determining the first display information of the two-dimensional object in the local space, an accurate reference basis may be provided for rendering and interaction of the two-dimensional object in the three-dimensional space. In modeling, the local space is used to define the shape and size of the object. In animation, the local space is used to describe local transformations of the object, such as rotation and/or scaling.

The first display information of the two-dimensional object in the local space includes at least the display size data of the two-dimensional object in the local space. In the local space, the display size data of the two-dimensional object is defined relative to its own coordinate system. For example, a rectangle may be defined by width and height, and a circle may be defined by radius. The position of the two-dimensional object in local space is usually based on an origin of the local coordinate system, which is usually the center of the two-dimensional object or the position of a vertex. In the embodiment of the present disclosure, the first display information of the two-dimensional object may be determined according to one or more feature points corresponding to the two-dimensional object. The feature points of the two-dimensional object include, but are not limited to, at least one of an edge point, a vertex, and a center point of the two-dimensional object. Which points are specifically used as the feature points of the two-dimensional object may be determined according to actual needs.

As an optional technical solution of the embodiment of the present disclosure, the display size data of the two-dimensional object includes display width and display height. Specifically, it may be the display width and the display height of an outer contour of the two-dimensional object or a collision box of the two-dimensional object. The collision box of the two-dimensional object may be a circumscribed rectangle of the two-dimensional object or a rectangle obtained by expanding the circumscribed rectangle.

Optionally, the first display information further includes position data and/or position offset data in local space, and the position offset data is used to indicate a base point referenced when the two-dimensional object performs transformation. The position offset data is expressed in percentage form. The first display information may further include the position data of the two-dimensional object in local space, which may specifically be spatial coordinate data used to represent the two-dimensional object in local space. The position offset data may specifically be used for display position data obtained by superimposing the position of the base point. In other words, the first display position is the local space position offset by superimposing the position offset data, which is used to represent the coordinates of the base point of the two-dimensional object in local space.

The first display information of the two-dimensional object may be determined according to one or more feature points corresponding to the two-dimensional object. The feature points of the two-dimensional object include, but are not limited to, at least one of an edge point, a vertex, and a center point of the two-dimensional object. Which points are specifically used as the feature points of the two-dimensional object may be determined according to actual needs.

As an optional technical solution of the embodiments of the present disclosure, determining the first display information of the two-dimensional object in local space includes: the two-dimensional object is detected to obtain a plurality of feature points of the two-dimensional object, and the first display information of the two-dimensional object in the local space is determined according to the plurality of feature points. Exemplarily, the detecting the two-dimensional object includes, but is not limited to, at least one of the following operations: edge detection on the two-dimensional object, center point detection on the two-dimensional object, and vertex detection on the two-dimensional object, and so on. By adopting this technical solution, the features of the two-dimensional object can be accurately identified, thereby accurately determining the display information of the two-dimensional object in the local space.

As another optional technical solution of the embodiments of the present disclosure, determining the first display information of the two-dimensional object in local space includes: a collision box of the two-dimensional object is determined, and the first display information of the two-dimensional object in local space is determined according to the collision box. In the process of rendering and interaction of the two-dimensional object, the collision box is a data structure used to detect object boundaries and interaction areas. By determining the collision box, the first display information of the two-dimensional object in local space can be further derived, which provides accurate data support for subsequent rendering and interaction. By adopting this technical solution, the first display information of the two-dimensional object in local space is determined through the collision box of the two-dimensional object, so that the first display information of the two-dimensional object can present an expected data structure, and a structured data basis is provided for the rendering of subsequent operation elements, thereby better simplifying the rendering manner of the operation elements.

Optionally, determining the collision box of the two-dimensional object includes: a collision box type corresponding to the two-dimensional object is determined, and the collision box of the two-dimensional object is determined according to the collision box type. Exemplarily, the collision box type includes, but is not limited to, at least one of the following types: an axis-aligned collision box, an oriented collision box, and a polygon collision box. The axis-aligned collision box is a rectangular box aligned with coordinate axes, which is suitable for static or simple dynamic objects. In this case, determining the collision box of the two-dimensional object may specifically be traversing all vertices of the two-dimensional object, taking the minimum and maximum horizontal and vertical coordinate values, and generating a rectangular box. The oriented collision box is a rectangular box that may be adjusted according to the rotation direction of the object, which is suitable for complex dynamic objects. The polygon collision box is suitable for objects with irregular shapes and is a convex polygon defined by a plurality of vertices. In this case, determining the collision box of the two-dimensional object may specifically be extracting a vertex list of the two-dimensional object and generating a convex hull as the collision box. As mentioned above, the shape of the collision box of the two-dimensional object can include a rectangle, and in this case, the display size data of the two-dimensional object can include display height and display width.

In the embodiments of the present disclosure, rendering the two-dimensional object into the three-dimensional space according to the first display information may specifically involve transforming the two-dimensional object from the local space into world space through a model matrix and the first display information, and then the two-dimensional object in the world space is transformed into a screen coordinate system of the three-dimensional space through a projection matrix, thereby the two-dimensional object is rendered into the three-dimensional space. The model matrix may specifically include translation, rotation, and scaling information. The translation is used to move the two-dimensional object from the origin of the local space to a target position in the world space. Further rotation or scaling is performed on the two-dimensional object in the world space according to needs, so that the requirements of the three-dimensional scene may be matched more flexibly. The projection transformation includes orthogonal projection or perspective projection, which depends specifically on scene requirements. The world space is a global coordinate system, and the position and orientation of all objects are defined relative to this coordinate system. In other words, the world space is used to describe the absolute position and orientation of an object in a scene. In scene layout, the world space is used to determine the position, rotation, and scaling of an object. During rendering, the world space is used to calculate global effects such as lighting and collision detection. In the three-dimensional space, the two-dimensional object needs to be given depth information (the Z coordinate) to determine the front-to-back relationship within the scene.

In an optional technical solution of the embodiment of the present disclosure, the first display information may be determined based on a preset data structure, and the preset data structure includes the display size data and the position offset data. If the attribute values of the two-dimensional object do not include the position offset data, the attribute value of the position offset data may be set to the default value (0, 0).

S120: an operation element corresponding to the two-dimensional object is determined, rendering configuration information of the operation element is determined, and the operation element is rendered into the three-dimensional space according to the first display information and the rendering configuration information to display the operation element on the interaction device; where the operation element is configured to control the two-dimensional object to perform a preset operation.

In the three-dimensional interaction scene, the operation element is an interaction control used to control the two-dimensional object to perform preset operations (such as rotation, scaling, and movement). In the embodiments of the present disclosure, by rendering the operation elements into the three-dimensional space and displaying the operation elements on the interaction device, the user may intuitively operate the two-dimensional object. The operation elements of the two-dimensional object are determined, and the rendering configuration information of the operation elements and the first display information of the two-dimensional object are combined, thereby achieving accurate rendering of the operation elements in the three-dimensional space.

The operation elements corresponding to the two-dimensional object may be preset or custom-set according to a configuration operation for the operation elements. The corresponding operation elements of different two-dimensional objects may be the same or different. In the case where there are various corresponding operation elements of the two-dimensional object, the corresponding operation elements of the different two-dimensional objects may be completely the same, partially the same, or completely different.

Similarly, the rendering configuration information of the operation elements may be preset fixed rendering configuration information or custom-set rendering configuration information according to a rendering configuration operation of the operation elements. The rendering configuration information of the operation elements may render the operation elements as a preset style. In other words, the rendering configuration information of the operation elements is used to configure the presentation style of the operation elements. Exemplarily, the rendering configuration information may include at least one of the following attributes of the operation elements: material, color, size, and shape. Thus, attributes such as the material, the color, the size, and the shape of the operation elements are set according to the rendering configuration information. The rendering configuration is dynamically adjusted according to the type and interaction state (such as selected and unselected state) of the operation elements. For example, the rotation handle uses a red material, and the scaling control uses a blue material.

In the embodiments of the present disclosure, the operation element may be an interaction control displayed in association with the two-dimensional object, which is used to control the two-dimensional object to perform the preset operation. Optionally, the operation elements and the two-dimensional object are relatively displayed in a preset display manner. In other words, at least part of display information of the operation elements may follow the change of the display information of the two-dimensional object.

As an optional technical solution of the embodiment of the present disclosure, one or more operation elements may be configured for the two-dimensional object in advance, that is, a mapping relationship between the two-dimensional objects and the operation elements is established. Optionally, the operation elements corresponding to the two-dimensional object are determined according to an identification and/or a type of the two-dimensional object. By adopting this technical solution, the operation elements corresponding to the two-dimensional object can be determined conveniently, quickly, and accurately.

In some embodiments of the present disclosure, rendering the operation element into the three-dimensional space according to the first display information and the rendering configuration information includes: a spatial rendering position of the operation element is determined according to the first display information and a type of the operation element, and the operation element is rendered into the three-dimensional space based on the rendering configuration information and the spatial rendering position. The spatial rendering position may be understood as a rendering position or a display position of the operation element in the three-dimensional space. As mentioned above, the relative display information of the operation elements of the same type and the two-dimensional object may be the same to simplify interaction operations. By adopting this technical solution, the spatial rendering position is determined based on the first display information and the type of the operation elements, thereby ensuring that the positional relationship between the operation elements and the two-dimensional object is accurate, supporting various operation element types, and adapting to different interaction requirements. The spatial rendering position and the rendering configuration information of the operation elements are transmitted to a rendering pipeline to generate the final visual effect, causing the user to operate the two-dimensional object intuitively. Through the dynamic rendering configuration, accurate rendering and dynamic adaptation of the operation elements are achieved, the visual expressiveness of the operation elements is improved, and the interaction experience with the two-dimensional object is enhanced.

In the technical solution of the embodiments of the present disclosure, the addition operation for the two-dimensional object is received through the interaction device, the first display information of the two-dimensional object in the local space is determined, and the two-dimensional object is rendered into the three-dimensional space according to the first display information. Since the first display information includes at least the display size data and the position offset data, and the position offset data is used to indicate the base point referenced when the two-dimensional object performs transformation, the two-dimensional object may be naturally integrated into the three-dimensional space, which is more coordinated and unified visually. The user may view and use the two-dimensional object in the three-dimensional scene more intuitively, and visual interference caused by a mismatch between two-dimensional display and three-dimensional display is reduced. Then, by determining the operation element corresponding to the two-dimensional object, determining the rendering configuration information of the operation element, and rendering the operation element into the three-dimensional space according to the first display information and the rendering configuration information to display the operation element on the interaction device, the two-dimensional object and the operation element may be mapped to the three-dimensional space conveniently, quickly, and accurately. Since the operation element is configured to control the two-dimensional object to perform the preset operation, the technical problem that it is difficult to apply the existing interaction logic of the two-dimensional object to the three-dimensional space is solved. Therefore, the presence of the operation element allows the user to directly operate the two-dimensional object in the three-dimensional space, which makes the operation of the two-dimensional object in the three-dimensional space more convenient and efficient, expands the applicable scenarios of the operation element, improves the cross-scene reuse capability of the operation element, and greatly improves the user experience in the information interaction process.

FIG. 2 is a schematic flowchart of another information interaction method provided in an embodiment of the present disclosure. On the basis of the above embodiments, the technical solution of this embodiment further refines how to determine the operation element of the two-dimensional object added to the three-dimensional space. Optionally, determining the operation element corresponding to the two-dimensional object includes: a type corresponding to the two-dimensional object is determined, and the operation element corresponding to the two-dimensional object is determined according to the type. For specific implementations, reference may be made to the description of this embodiment. The technical features the same as or similar to those of the above embodiments are not repeated here. As shown in FIG. 2, the method in this embodiment may specifically include the following steps.

S210: An addition operation for a two-dimensional object is received through an interaction device, first display information of the two-dimensional object in a local space is determined, and the two-dimensional object is rendered into a three-dimensional space according to the first display information; where the first display information includes at least display size data.

S220: a type corresponding to the two-dimensional object is determined, an operation element corresponding to the two-dimensional object is determined according to the type, rendering configuration information of the operation element is determined, and the operation element is rendered into the three-dimensional space according to the first display information and the rendering configuration information to display the operation element on the interaction device.

In the embodiments of the present disclosure, the type corresponding to the two-dimensional object may be determined according to attribute information of the two-dimensional object. Exemplarily, the attribute information of the two-dimensional object may include, but not limited to one or more of the following information: a shape, an operation requirement, and an application scenario of the two-dimensional object. In some instances, the type corresponding to the two-dimensional object may include at least one of the following types: an image, a text box, and a collision box.

Optionally, determining the type corresponding to the two-dimensional object includes: an attribute field corresponding to the two-dimensional object is obtained, and the type corresponding to the two-dimensional object is determined according to the attribute field, where the attribute field is used to distinguish different types of two-dimensional objects; and/or a preset type identification corresponding to the two-dimensional object is obtained, and the type corresponding to the two-dimensional object is determined according to the preset type identification, where the preset type identification corresponds to the type, and the like.

Specifically, after the type corresponding to the two-dimensional object is determined, the operation element may be dynamically generated according to the type of the two-dimensional object and an operation element type. That is, when the types of the two-dimensional objects are the same, the corresponding operation elements are the same. For example, if the two-dimensional object is an editable image, a rotation handle, a scaling control, a moving arrow, and the like may be generated. The operation element may also be displayed at different positions of the two-dimensional object according to the corresponding interaction operation of operation element. That is, a relative display position of the operation element and the two-dimensional object may be associated with the preset operation that the operation element controls the two-dimensional object to perform. By determining the type of the two-dimensional object, the operation element functions matching the two-dimensional object can be dynamically generated, thereby improving the intuitiveness and efficiency of interaction.

As an optional technical solution of the embodiments of the present disclosure, before determining the operation element corresponding to the two-dimensional object according to the type, the method further includes: an interaction configuration operation for the type corresponding to the two-dimensional object is received, and an operation element corresponding to the type of the two-dimensional object is determined according to the interaction configuration operation, where the interaction configuration operation is used for configuring a correspondence between the type and the operation element. In the three-dimensional interaction scene, the interaction configuration operation is a key step used to configure the relationship between the type of the two-dimensional object and the corresponding operation element. By receiving and parsing the interaction configuration operation, the operation element (such as the rotation handle and the scaling control) matching the type of the two-dimensional object may be dynamically generated, thereby improving the flexibility of interaction and the user experience.

Each two-dimensional object may correspond to one or more operation elements. After the operation element corresponding to the two-dimensional object of the type is determined according to the interaction configuration operation, a mapping table may be used to store the correspondence between the type of the two-dimensional object and the operation element type. The correspondence between the type of the two-dimensional object and the operation element type may be determined in turn by querying the mapping table. Thus, the operation elements may be quickly and accurately determined.

As an optional implementation of the embodiments of the present disclosure, before determining the rendering configuration information of the operation element, the method further includes: a rendering configuration operation for the operation element is received, and the rendering configuration information corresponding to the operation element is determined according to the rendering configuration operation. The rendering configuration operation may be understood as an operation of configuring the information used for rendering the operation element. Specifically, the rendering configuration operation may include an operation of setting one or more attribute information items such as material, color, size, and shape for the operation element (such as the rotation handle and the scaling control). By adopting this technical solution, the customized setting of the rendering configuration information of the operation element is achieved by receiving the rendering configuration operation for the operation element. The rendering configuration information corresponding to the operation element is determined according to the rendering configuration operation, so that the operation element is presented on the interaction device in an expected style.

In the embodiments of the present disclosure, the composite capability based on the three-dimensional space is defined, that is, the modal combination capabilities of Immediate Mode Graphical User Interface with the first display information, and the rendering logic is decoupled from the interaction logic of the operation element. The rendering capability is dynamically injected through an external module or component, such that the system structure is clearer and is convenient to maintain and expand. A unified set of editing capability is achieved, which supports the editing scene of the two-dimensional object and does not affect the interaction stability.

In the technical solution of the embodiment of the present disclosure, the type corresponding to the two-dimensional object is determined, and the operation element corresponding to the two-dimensional object is determined according to the type, such that operation elements may be classified and configured for a plurality of two-dimensional objects, and the configuration of the operation elements is more structured, thereby reducing the interaction complexity, and achieving comprehensive improvement of interaction efficiency, visual consistency, scene adaptability, and performance optimization. This not only simplifies the user operation process, but also enhances the user experience through dynamic adaptation and flexible expansion, which can be applied to complex three-dimensional interaction scenarios.

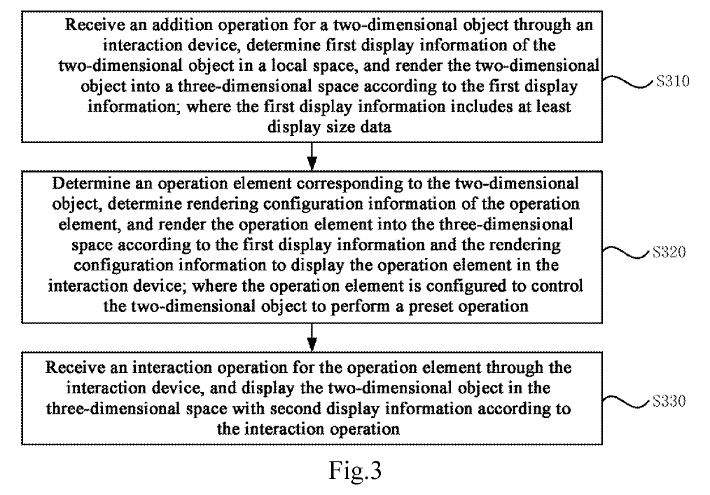

FIG. 3 is a schematic flowchart of another information interaction method provided in an embodiment of the present disclosure. On the basis of the above embodiments, the technical solution of this embodiment may operate the two-dimensional object in the three-dimensional space. Optionally, after displaying the operation element on the interaction device, the method further includes: an interaction operation for the operation element is received through the interaction device, and the two-dimensional object in the three-dimensional space is displayed with second display information according to the interaction operation. For specific implementations, reference may be made to the description of this embodiment. The technical features the same as or similar to those of the above embodiments are not repeated here. As shown in FIG. 3, the method in this embodiment may specifically include:

S310: An addition operation for a two-dimensional object is received through an interaction device, first display information of the two-dimensional object in a local space is determined, and the two-dimensional object is rendered into a three-dimensional space according to the first display information; where the first display information includes at least display size data.

S320: An operation element corresponding to the two-dimensional object is determined, rendering configuration information of the operation element is determined, and the operation element is rendered into the three-dimensional space according to the first display information and the rendering configuration information to display the operation element on the interaction device; where the operation element is used to control the two-dimensional object to perform a preset operation.

S330: An interaction operation for the operation element is received through the interaction device, and the two-dimensional object in the three-dimensional space is displayed with second display information according to the interaction operation.

In the embodiments of the present disclosure, the interaction operation for the operation element may be understood as an operation used to trigger the operation element, or an operation of interacting with the operation element. Exemplarily, the interaction operation for the operation element may be at least one of the following operations: clicking and/or dragging, and rotating the operation element. The interaction operation may be input through an input component (such as a mouse, a keyboard, a remote controller) of the interaction device or through touch input.

Specifically, the displaying the two-dimensional object in the three-dimensional space with the second display information for the two-dimensional object according to the interaction operation may include: a first trigger position corresponding to the interaction operation on the interaction device is determined, and the first trigger position is transformed into a second trigger position corresponding to the three-dimensional space; and the second display information of the two-dimensional object is determined according to the second trigger position and preset interaction logic corresponding to the operation element, and the two-dimensional object in the three-dimensional space is displayed with the second display information. In the embodiments of the present disclosure, the second display information is associated with the interaction operation, and may be the same as or different from at least part of the display information in the first display information.

It may be understood that, in an actual scene, it is often difficult to predict what form of interaction is performed with the two-dimensional object and which operation element is interacted with, and therefore the interaction operation received through the interaction device is also often difficult to predict. In the case where the interaction operation is received through the interaction device, the first trigger position of the interaction operation input on the interaction device may be first obtained according to the position of the user operation, and then the screen coordinate (such as the mouse click position or the touch point position) is transformed into a ray or coordinate point in the three-dimensional space through inverse transformation, that is, the second trigger position, so as to identify the operated operation element through the second trigger position. The second display information (such as the position, the rotation angle, and the scaling ratio) of the two-dimensional object may be determined according to the second trigger position and the preset interaction logic of the operation element, and the display state of the two-dimensional object in the three-dimensional space is dynamically updated. Specifically, attributes such as the material, the color, and the size of the two-dimensional object may be set according to the second display information, and the two-dimensional object is rendered into the three-dimensional space. Thus, the two-dimensional object is controlled by the operation element to perform the corresponding operation.

It should be noted that the interaction operation may be an instantaneous operation or a continuous operation, and wherein continuous operation may include, but is not limited to, an operation continuously applied to the interaction device and/or a plurality of operations input within a preset time period, and the like. There may be one or more first trigger positions corresponding to the interaction operation. Since the second trigger position is obtained by performing the space coordinate transformation on the first trigger position, there may also be one or more second trigger positions.

In the technical solution of the embodiment of the present disclosure, after the operation element is displayed on the interaction device, the interaction operation for the operation element is received through the interaction device, and the two-dimensional object is displayed in the three-dimensional space with the second display information according to the interaction operation, so that dynamic updating and precise control of the two-dimensional object in the three-dimensional space may be achieved through the existing operation logic. The adaptability of the operation element to the complex interaction scene is enhanced, and the technical solution is applicable to various three-dimensional interaction scenes, thereby improving the interaction experience.

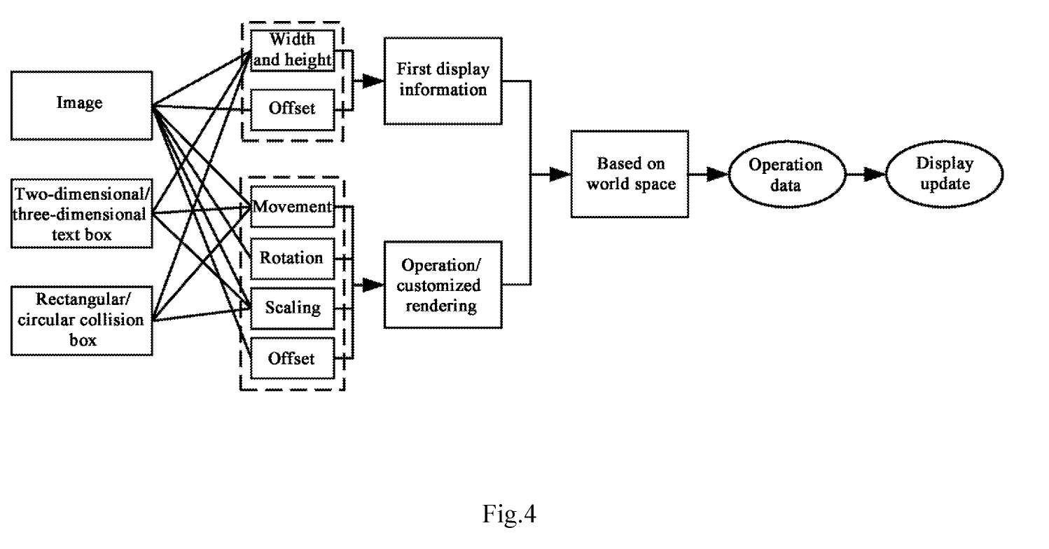

FIG. 4 is a schematic flowchart of an optional instance of an information interaction method according to an embodiment of the present disclosure. In this embodiment, the data structure of the first display information may be predefined. For example, the data structure of the first display information may specifically include the display width, the display height, and the position offset data. The interaction operation supported in the three-dimensional space may also be preset, and the preset interaction logic corresponding to the operation element supporting the interaction operation may be defined. Specifically, as shown in FIG. 4, the operated two-dimensional object may include an image, a two-dimensional text box, a rectangular or circular collision box, and the like, and the configurable operation modes include rotation, movement, scaling, and offset, etc. The interaction operations configured for different two-dimensional objects may be the same or different. In the entire execution link, the operation element for interaction is dynamically created according to the interaction operation customized configured for the two-dimensional object by using a preset programming mode for building a user interface (such as the immediate mode graphical user interface). All operation elements are composed of the same set of interaction capabilities in the two-dimensional space. For example, the four points (upper, lower, left, and right) of the rotation operation are respectively composed of four plane interaction components. When interacting with the two-dimensional object displayed in the three-dimensional space, the screen coordinate corresponding to the screen position triggered by the interaction operation applied to the two-dimensional object may be recorded and inversely transformed into the three-dimensional space coordinate. The calculation is performed in the world space based on the structure data (the first display information) of the two-dimensional object, the interaction combination (the interaction operation supported by the two-dimensional object, that is, the operation element corresponding to the two-dimensional object), and the customized rendering configuration, and the corresponding three-dimensional operation data is finally output to update the display information of the two-dimensional object according to the three-dimensional operation data. The dynamic generation and precise control of the operation element are achieved with this technical solution, and the efficient unity of the rendering and interaction logic is ensured.

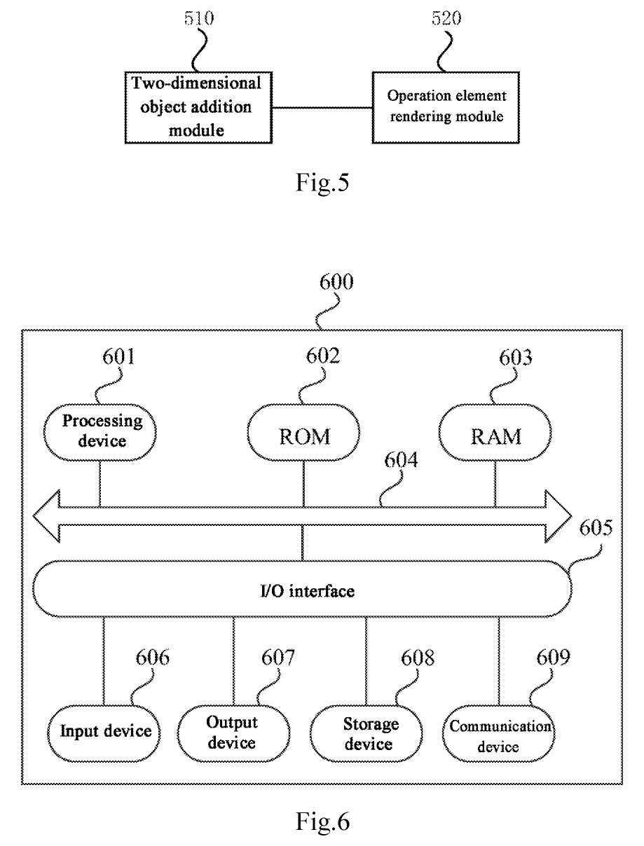

FIG. 5 is a schematic structural diagram of an information interaction apparatus provided in an embodiment of the present disclosure. As shown in FIG. 5, the information interaction apparatus includes a two-dimensional object addition module 510 and an operation element rendering module 520, wherein the two-dimensional object addition module 510 is configured to receive an addition operation for a two-dimensional object through an interaction device, determine first display information of the two-dimensional object in a local space, and render the two-dimensional object into a three-dimensional space according to the first display information; where the first display information includes at least display size data and position offset data; and the operation element rendering module 520 is configured to determine an operation element corresponding to the two-dimensional object, determine rendering configuration information of the operation element, and render the operation element into the three-dimensional space according to the first display information and the rendering configuration information to display the operation element on the interaction device; where the operation element is used to control the two-dimensional object to perform a preset operation.

In the technical solution of the embodiment of the present disclosure, the two-dimensional object addition module 510 receives the addition operation for the two-dimensional object through the interaction device, determines the first display information of the two-dimensional object in the local space, and renders the two-dimensional object into the three-dimensional space according to the first display information. Since the first display information includes at least the display size data and the position offset data, and the position offset data is used to indicate the base point referenced when the two-dimensional object performs transformation, the two-dimensional object may be naturally integrated into the three-dimensional space, which is more coordinated and unified visually. The user may view and use the two-dimensional object in the three-dimensional scene more intuitively, and visual interference caused by a mismatch between two-dimensional display and three-dimensional display is reduced. Then, the operation element rendering module 520 determines the operation element corresponding to the two-dimensional object, determines the rendering configuration information of the operation element, and renders the operation element into the three-dimensional space according to the first display information and the rendering configuration information to display the operation element on the interaction device. Thus, the two-dimensional object and the operation element may be mapped to the three-dimensional space conveniently, quickly, and accurately. Since the operation element is configured to control the two-dimensional object to perform the preset operation, the technical problem that it is difficult to apply the existing interaction logic of the two-dimensional object to the three-dimensional space is solved. Therefore, the presence of the operation element allows the user to directly operate the two-dimensional object in the three-dimensional space, which makes the operation of the two-dimensional object in the three-dimensional space more convenient and efficient, expands the applicable scenarios of the operation element, improves the cross-scene reuse capability of the operation element, and greatly improves the user experience in the information interaction process.

On the basis of any optional technical solution in the embodiments of the present disclosure, optionally, the operation element rendering module 520 is specifically used to determine a type corresponding to the two-dimensional object, and determine the operation element corresponding to the two-dimensional object according to the type.

On the basis of any optional technical solution in the embodiments of the present disclosure, optionally, the information interaction apparatus further includes an operation element configuration module. The operation element configuration module is used to, before the operation element corresponding to the two-dimensional object is determined according to the type, receive an interaction configuration operation for the type corresponding to the two-dimensional object, and determine an operation element corresponding to the two-dimensional object of the type according to the interaction configuration operation, where the interaction configuration operation is used for configuring a correspondence between the type and the operation element.

On the basis of any optional technical solution in the embodiments of the present disclosure, optionally, the information interaction apparatus further includes a rendering information configuration module. The rendering information configuration module is used to, before the rendering configuration information of the operation element is determined, receive a rendering configuration operation for the operation element, and determine the rendering configuration information corresponding to the operation elements according to the rendering configuration operation.

On the basis of any optional technical solution in the embodiments of the present disclosure, optionally, the operation element rendering module 520 is specifically used to determine a spatial rendering position of the operation element according to the first display information and a type of the operation element, and render the operation element into the three-dimensional space based on the rendering configuration information and the spatial rendering position.

On the basis of any optional technical solution in the embodiments of the present disclosure, optionally, the information interaction apparatus further includes a three-dimensional space interaction module. The three-dimensional space interaction module is used to, after the operation element on the interaction device is displayed, receive an interaction operation for the operation element through the interaction device, and display the two-dimensional object in the three-dimensional space with second display information according to the interaction operation.

On the basis of any optional technical solution in the embodiments of the present disclosure, optionally, the three-dimensional space interaction module includes a trigger position determination unit and an object display update unit. The trigger position determination unit is used to determine a first trigger position corresponding to the interaction operation on the interaction device, and transform the first trigger position into a second trigger position corresponding to the three-dimensional space; and the object display update unit is configured to determine second display information of the two-dimensional object according to the second trigger position and preset interaction logic corresponding to the operation element, and display the two-dimensional object in the three-dimensional space with the second display information.

On the basis of any optional technical solution in the embodiments of the present disclosure, optionally, the two-dimensional object addition module 510 is specifically used to determine a collision box of the two-dimensional object, and determine the first display information of the two-dimensional object in the local space according to the collision box.

On the basis of any optional technical solution in the embodiments of the present disclosure, optionally, the shape of the outer contour of the two-dimensional object or the shape of the collision box of the two-dimensional object includes a rectangle, and the display size data includes a display height and a display width.

On the basis of any optional technical solution in the embodiments of the present disclosure, optionally, the first display information further includes position offset data, and the position offset data is used to indicate a base point referenced when the two-dimensional object performs transformation.

The information interaction apparatus provided in the embodiments of the present disclosure can perform the information interaction method provided in any embodiment of the present disclosure, and possesses corresponding functional modules and beneficial effects for performing the information interaction method.

It is worth noting that the various units and modules included in the above apparatus are only divided according to functional logic, but are not limited to the above division, as long as the corresponding functions can be implemented. In addition, the specific names of the functional units are only for the convenience of distinguishing from each other, and are not used to limit the protection scope of the embodiments of the present disclosure.

Referring to FIG. 6 below, which shows a schematic structural diagram of an electronic device (such as a terminal device or a server) 600 suitable for implementing embodiments of the present disclosure. The terminal device in the embodiments of the present disclosure may include, but is not limited to, mobile terminals such as a mobile phone, a laptop, a digital broadcast receiver, a PDA (personal digital assistant), a PAD (tablet computer), a PMP (portable multimedia player),

and a vehicle-mounted terminal (such as a vehicle navigation terminal), and fixed terminals such as a digital TV and a desktop computer. The electronic device shown in FIG. 6 is only one example and should not impose any limitation on the functions and scope of use of the embodiment of the present disclosure.

As shown in FIG. 6, the electronic device 600 may include a processing device (such as a central processing unit and a graphics processor) 601, which may perform various appropriate actions and processes according to a program stored in a read-only memory (ROM) 602 or a program loaded from a storage device 608 into a random access memory (RAM) 603. The RAM 603 further stores various programs and data required for the operations of the electronic device 600. The processing device 601, the ROM 602, and the RAM 603 are connected to each other through a bus 604. An input/output (I/O) interface 605 is also connected to the bus 604.

Typically, the following devices may be connected to the I/O interface 605: an input device 606 including, for example, a touchscreen, a touchpad, a keyboard, a mouse, a camera, a microphone, an accelerometer, and a gyroscope; an output device 607 including, for example, a liquid crystal display (LCD), a speaker, and a vibrator; the storage device 608 including, for example, a magnetic tape and a hard disk; and a communication device 609. The communication device 609 may allow the electronic device 600 to perform wireless or wired communication with other devices to exchange data. Although FIG. 6 shows the electronic device 600 having various devices, it should be understood that it is not mandatory to implement or have all the devices shown. Alternatively, more or fewer devices may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication device 609, or installed from the storage device 608, or installed from the ROM 602. When the computer program is executed by the processing device 601, the functions defined in the method of the embodiment of the present disclosure are executed.

The names of messages or information exchanged between a plurality of devices in the implementation of the present disclosure are only used for illustrative purposes and are not used to limit the scope of these messages or information.

The electronic device provided in the embodiments of the present disclosure belongs to the same inventive concept as the information interaction method provided in the above embodiment. For the technical details not described in detail in the embodiment of the present disclosure, reference may be made to the above embodiment, and this embodiment has the same beneficial effects as the above embodiment.

An embodiment of the present disclosure provides a computer storage medium having a computer program stored thereon, where the information interaction method provided in the above embodiments is implemented when the program is executed by a processor.

It should be noted that the above computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include a data signal propagated on a baseband or as a part of a carrier, and computer-readable program code is carried therein. The data signal propagated in this manner may take a plurality of forms, including but not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to, wires, an optical cable, a radio frequency (RF), or any suitable combination thereof.

According to one or more embodiments of the present disclosure, [example one] provides an information interaction method, including: receiving an addition operation for a two-dimensional object through an interaction device, determining first display information of the two-dimensional object in a local space, and rendering the two-dimensional object into a three-dimensional space according to the first display information; where the first display information includes at least display size data; and determining an operation element corresponding to the two-dimensional object, determining rendering configuration information of the operation element, and rendering the operation element into the three-dimensional space according to the first display information and the rendering configuration information to display the operation element on the interaction device; where the operation element is used to control the two-dimensional object to perform a preset operation.

According to one or more embodiments of the present disclosure, [example two] provides the method of example one, and the method further includes: optionally, determining the operation element corresponding to the two-dimensional object includes: determining a type corresponding to the two-dimensional object, and determining the operation element corresponding to the two-dimensional object according to the type.

According to one or more embodiments of the present disclosure, [example three] provides the method of example two, and the method further includes: optionally, before determining the operation element corresponding to the two-dimensional object according to the type, the method further includes: receiving an interaction configuration operation for the type corresponding to the two-dimensional object, and determining an operation element corresponding to the type of two-dimensional object according to the interaction configuration operation, where the interaction configuration operation is used for configuring a correspondence between the type and the operation element.

According to one or more embodiments of the present disclosure, [example four] provides the method of example two, and the method further includes: optionally, before determining the rendering configuration information of the operation element, the method further includes: receiving a rendering configuration operation for the operation element, and determining the rendering configuration information corresponding to the operation element according to the rendering configuration operation.

According to one or more embodiments of the present disclosure, [example five] provides the method of example one, and the method further includes: optionally, rendering the operation element into the three-dimensional space according to the first display information and the rendering configuration information includes: determining a spatial rendering position of the operation element according to the first display information and a type of the operation element, and rendering the operation element into the three-dimensional space based on the rendering configuration information and the spatial rendering position.

According to one or more embodiments of the present disclosure, [example six] provides the method of example one, and the method further includes: optionally, after displaying the operation element on the interaction device, the method further includes:

receiving an interaction operation for the operation element through the interaction device, and displaying the two-dimensional object in the three-dimensional space with second display information according to the interaction operation.

According to one or more embodiments of the present disclosure, [example seven] provides the method of example six, and the method further includes: optionally, displaying the two-dimensional object in the three-dimensional space with the second display information according to the interaction operation includes: determining a first trigger position corresponding to the interaction operation on the interaction device, and transforming the first trigger position into a second trigger position corresponding to the three-dimensional space; and determining the second display information of the two-dimensional object according to the second trigger position and preset interaction logic corresponding to the operation element, and displaying the two-dimensional object in the three-dimensional space with the second display information.

According to one or more embodiments of the present disclosure, [example eight] provides the method of example one, and the method further includes: optionally, determining the first display information of the two-dimensional object in local space includes: determining a collision box of the two-dimensional object, and determining the first display information of the two-dimensional object in local space according to the collision box.

According to one or more embodiments of the present disclosure, [example nine] provides the method of example eight, and the method further includes: optionally, the shape of an outer contour of the two-dimensional object or the shape of the collision box of the two-dimensional object includes a rectangle, and the display size data includes a display height and a display width.

According to one or more embodiments of the present disclosure, [example ten] provides the method of example one, and the method further includes: optionally, the first display information further includes position offset data, and the position offset data is used to indicate a base point referenced when the two-dimensional object performs transformation.

According to one or more embodiments of the present disclosure, [example eleven] provides an information interaction apparatus, including: a two-dimensional object addition module, used to receive an addition operation for a two-dimensional object through an interaction device, determine first display information of the two-dimensional object in a local space, and render the two-dimensional object into a three-dimensional space according to the first display information; where the first display information includes at least display size data; and an operation element rendering module, used to determine an operation element corresponding to the two-dimensional object, determine rendering configuration information of the operation element, and render the operation element into the three-dimensional space according to the first display information and the rendering configuration information to display the operation element on the interaction device; where the operation element is used to control the two-dimensional object to perform a preset operation.

In some implementations, clients and servers may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs, which, when executed by the electronic device, cause the electronic device to: receive an addition operation for a two-dimensional object through an interaction device, determine first display information of the two-dimensional object in a local space, and render the two-dimensional object into a three-dimensional space according to the first display information; where the first display information includes at least display size data; and determine an operation element corresponding to the two-dimensional object, determine rendering configuration information of the operation element, and render the operation element into the three-dimensional space according to the first display information and the rendering configuration information to display the operation element on the interaction device; where the operation element is configured to control the two-dimensional object to perform a preset operation.

The computer program code for performing the operations of the present disclosure may be written in one or more programming languages or a combination thereof, where the programming languages include, but are not limited to, an object-oriented programming language such as Java, Smalltalk, and C++, and further include conventional procedural programming languages such as "C" language or similar programming languages. The program code may be completely executed on a computer of a user, partially executed on a computer of a user, executed as an independent software package, partially executed on a computer of a user and partially executed on a remote computer, or completely executed on a remote computer or a server. In the case of involving a remote computer, the remote computer may be connected to a computer of a user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units or modules involved in the embodiments of the present disclosure may be implemented in a software manner or a hardware manner. The name of the unit or module does not constitute a limitation on the unit or module itself under certain circumstances. For example, the two-dimensional object addition module may also be described as "a module that receives an addition operation for a two-dimensional object".

The functions described above may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), and the like.

In the context of the present disclosure, the machine-readable medium may be a tangible medium that may contain or store programs for use by or in combination with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination thereof. More specific examples of the machine-readable storage medium may include an electrical connection based on one or more lines, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an illustration of the technical principles employed. Those skilled in the art should understand that the scope of disclosure involved in the present disclosure is not limited to the technical solutions formed by the specific combinations of the above technical features, and should also cover, without departing from the above disclosed concept, other technical solutions formed by any combination of the above technical features or their equivalent features. For example, the above features and the technical features provided in the present disclosure with similar functions (but not limited thereto) may be replaced each other to form a technical solution.

Furthermore, although the operations have been described in a particular order, this should not be understood as requiring the operations to be performed in the particular order shown or in a sequential order. Under certain circumstances, multitasking and parallel processing may be advantageous. Similarly, although the above discussion contains several specific implementation details, these should not be construed as limitations on the scope of the present disclosure. Certain features that are described in the context of separate embodiments may also be implemented in combination in a single embodiment. Conversely, various features described in the context of a single embodiment may also be implemented in a plurality of embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only exemplary forms for implementing the claims.

1. An information interaction method, comprising:
receiving an addition operation for a two-dimensional object through an interaction device, determining first display information of the two-dimensional object in a local space, and rendering the two-dimensional object into a three-dimensional space according to the first display information; wherein the first display information comprises at least display size data; and
determining an operation element corresponding to the two-dimensional object, and determining rendering configuration information of the operation element, rendering the operation element into the three-dimensional space according to the first display information and the rendering configuration information, to display the operation element on the interaction device; wherein the operation element is used to control the two-dimensional object to perform a preset operation.

2. The information interaction method of claim 1, wherein determining the operation element corresponding to the two-dimensional object comprises:
determining a type corresponding to the two-dimensional object, and determining the operation element corresponding to the two-dimensional object according to the type.

3. The information interaction method of claim 2, wherein before determining the operation element corresponding to the two-dimensional object according to the type, the method further comprises:
receiving an interaction configuration operation for the type corresponding to the two-dimensional object, and determining an operation element corresponding to the type of the two-dimensional object according to the interaction configuration operation, wherein the interaction configuration operation is used for configuring a correspondence between the type and the operation element.

4. The information interaction method of claim 2, wherein before determining the rendering configuration information of the operation element, the method further comprises:
receiving a rendering configuration operation for the operation element, and determining the rendering configuration information corresponding to the operation element according to the rendering configuration operation.

5. The information interaction method of claim 1, wherein rendering the operation element into the three-dimensional space according to the first display information and the rendering configuration information comprises:
determining a spatial rendering position of the operation element according to the first display information and a type of the operation element, and rendering the operation element into the three-dimensional space based on the rendering configuration information and the spatial rendering position.

6. The information interaction method of claim 1, wherein after displaying the operation element on the interaction device, the method further comprises:
receiving an interaction operation for the operation element through the interaction device, and displaying the two-dimensional object in the three-dimensional space with second display information according to the interaction operation.

7. The information interaction method of claim 6, wherein displaying the two-dimensional object in the three-dimensional space with the second display information according to the interaction operation comprises:
determining a first trigger position corresponding to the interaction operation on the interaction device, and transforming the first trigger position into a second trigger position corresponding to the three-dimensional space; and
determining the second display information of the two-dimensional object according to the second trigger position and preset interaction logic corresponding to the operation element, and displaying the two-dimensional object in the three-dimensional space with the second display information.

8. The information interaction method of claim 1, wherein determining the first display information of the two-dimensional object in the local space comprises:
determining a collision box of the two-dimensional object, and determining the first display information of the two-dimensional object in the local space according to the collision box.

9. The information interaction method of claim 8, wherein a shape of an outer contour of the two-dimensional object or a shape of the collision box of the two-dimensional object comprises a rectangle, and the display size data comprises a display height and a display width.

10. The information interaction method of claim 1, wherein the first display information further comprises position offset data, and the position offset data is used to indicate a base point referenced when the two-dimensional object performs transformation.

11. An electronic device, comprising:
a memory and a processor;
wherein the memory is configured to store one or more computer instructions which, when executed by the processor, cause the processor to:
receive an addition operation for a two-dimensional object through an interaction device, determine first display information of the two-dimensional object in a local space, and render the two-dimensional object into a three-dimensional space according to the first display information; wherein the first display information comprises at least display size data; and
determine an operation element corresponding to the two-dimensional object, and determine rendering configuration information of the operation element, render the operation element into the three-dimensional space according to the first display information and the rendering configuration information, to display the operation element on the interaction device; wherein the operation element is used to control the two-dimensional object to perform a preset operation.

12. The device according to claim 11, wherein the instructions causing the processor to determine the operation element corresponding to the two-dimensional object comprise instructions causing the processor to:
determine a type corresponding to the two-dimensional object, and determine the operation element corresponding to the two-dimensional object according to the type.

13. The device according to claim 12, wherein the instructions causing the processor to, before determining the operation element corresponding to the two-dimensional object according to the type, further comprise instructions causing the processor to:
receive an interaction configuration operation for the type corresponding to the two-dimensional object, and determine an operation element corresponding to the type of the two-dimensional object according to the interaction configuration operation, wherein the interaction configuration operation is used for configuring a correspondence between the type and the operation element.

14. The device according to claim 12, wherein the instructions causing the processor to determine the rendering configuration information of the operation element comprise instructions causing the processor to:
receive a rendering configuration operation for the operation element, and determine the rendering configuration information corresponding to the operation element according to the rendering configuration operation.

15. The device according to claim 11, wherein the instructions causing the processor to render the operation element into the three-dimensional space according to the first display information and the rendering configuration information comprise instructions causing the processor to:
determine a spatial rendering position of the operation element according to the first display information and a type of the operation element, and render the operation element into the three-dimensional space based on the rendering configuration information and the spatial rendering position.

16. The device according to claim 11, wherein the instructions causing the processor to, after displaying the operation element on the interaction device, further comprise instructions causing the processor to:
receive an interaction operation for the operation element through the interaction device, and display the two-dimensional object in the three-dimensional space with second display information according to the interaction operation.

17. The device according to claim 16, wherein the instructions causing the processor to display the two-dimensional object in the three-dimensional space with the second display information according to the interaction operation comprise instructions causing the processor to:
determine a first trigger position corresponding to the interaction operation on the interaction device, and transform the first trigger position into a second trigger position corresponding to the three-dimensional space; and
determine the second display information of the two-dimensional object according to the second trigger position and preset interaction logic corresponding to the operation element, and display the two-dimensional object in the three-dimensional space with the second display information.

18. The device according to claim 11, wherein the instructions causing the processor to determine the first display information of the two-dimensional object in the local space comprise instructions causing the processor to:
determine a collision box of the two-dimensional object, and determine the first display information of the two-dimensional object in the local space according to the collision box.

19. The device according to claim 18, wherein a shape of an outer contour of the two-dimensional object or a shape of the collision box of the two-dimensional object comprises a rectangle, and the display size data comprises a display height and a display width.

20. A non-transitory storage medium comprising computer-executable instructions stored thereon which, when executed by a processor, cause the processor to:
receive an addition operation for a two-dimensional object through an interaction device, and determine first display information of the two-dimensional object in a local space, and render the two-dimensional object into a three-dimensional space according to the first display information; wherein the first display information comprises at least display size data; and
determine an operation element corresponding to the two-dimensional object, and determine rendering configuration information of the operation element, render the operation element into the three-dimensional space according to the first display information and the rendering configuration information, to display the operation element on the interaction device; wherein the operation element is used to control the two-dimensional object to perform a preset operation.
